(19) United States
(12) Patent Application Publication
(10) Pub. No.: US 2001/0046265 A1
(43) Pub. Date: Nov. 29, 2001

(54) Video source coding with motion prediction and block effect filtering

(75) Inventor: Nadine Assaf, Paris (FR)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/863,311

(22) Filed: May 24, 2001

(30) Foreign Application Priority Data
May 29, 2000 (FR) 0006841

(51) Int. Cl. H04N 7/12

(52) U.S. Cl. 375/240.16; 375/240.12; 375/240.24; 375/240.03; 375/240.2

(57) ABSTRACT

The invention proposes a form of video source coding that is particularly suitable for transmission over a channel at a low bit rate and with a high error rate, such as a wireless transmission channel. It proposes to use block coding with motion prediction and employing a plurality of reference pictures. The reference pictures are subjected to block effect filtering. A reference picture is selected when coding a picture. By using a plurality of reference pictures, the invention limits transmission channel time propagation errors. Because the reference pictures are subjected to block effect filtering, transmission timing errors are corrected independently of intrinsic errors caused by block coding.

### BACKGROUND OF THE INVENTION

Wireless transmission is characterized by a relatively low transmission bit rate and a high error rate. Where the transmission bit rate is concerned, a low bit rate means bit rate values less than 100 kbit/s, for example GSM channels at 14 kbit/s. High error rates means error rates greater than 10⁻⁶, or even greater than 10⁻⁴.

The ITU-T H.263+ standard proposes solutions for video source coding. The standard comprises an obligatory common part and a set of optional appendices which can be implemented in addition to the common part of the standard. The standard gives no indication as to the quality of the pictures obtained or the combination of appendices that apply in given circumstances, in particular for wireless transmission. Implementing all the appendices yields a system that is difficult to apply to wireless transmission because of the low transmission bit rate available and because of the error rate.

The common part of the H.263+ standard proposes block coding with prediction. A distinction is made in a sequence of pictures between pictures sent integrally (referred to as “I” pictures), pictures that are not transmitted integrally but predicted from a preceding picture (referred to as “P” pictures), and pictures that are not transmitted integrally but which are predicted from a preceding picture and a succeeding picture. The coding process uses the following steps for a picture including blocks or macroblocks made up of a plurality of blocks, typically six blocks of which four are luminance blocks and two are chrominance blocks:

estimating motion of blocks or macroblocks of each picture,

predicting motion compensation relative to a reference picture, and

coding for transmission, typically by coding with compression (including discrete cosine transform (DCT), quantizing and variable length coding (VLC)).

The decoding process uses the converse steps to reconstitute each picture.

Appendix J of the standard proposes a solution to the problem of block effects. In block coding, processing blocks of pixels can lead to sudden variations in pixel values on moving from one block to another. Squares corresponding to the blocks then appear in the transmitted picture. Appendix J proposes to use a block edge filter in the coding loop to limit the block effect. The filtering is applied to edges of blocks formed of 8×8 pixels. Pixels from the edge of each block are filtered; for the pixels of a vertical edge, appendix J proposes an example of filtering on four adjacent horizontal pixels, and for the pixels of a horizontal edge an example of filtering on four adjacent vertical pixels. The filter function is triangular.

The assessment of the elimination of block edge effects achieved by the method proposed in appendix J is essentially qualitative. The aim is to make block effects imperceptible to the human eye. In quantitative terms, this corresponds to a limitation on high-frequency components of the picture or on the difference between the values of adjacent pixels.

Appendix N of the standard proposes to use a plurality of reference pictures (memory pictures) for picture prediction. It proposes, in the coder, selecting one memory picture from the available pictures to optimize coding quality. The choice of the memory picture to be used for prediction coding is transmitted to the decoder, which uses the appropriate memory picture as a function of instructions received from the coder. The solution proposed in appendix N circumvents the propagation time error.

### OBJECTS AND SUMMARY OF THE INVENTION

The invention proposes a solution to the problem of video quality for wireless transmission systems. It proposes in particular a solution to the problem of block artefacts or block effects caused by block coding. It improves picture quality; independently of this picture quality improvement, the invention limits problems associated with transmission.

To be more precise, the invention proposes a picture block coding method with motion prediction, using a plurality of reference pictures which have undergone block effect filtering and selecting a reference picture from said reference pictures when coding a picture.

The invention also proposes a picture block coding system with motion prediction, including a motion estimator receiving a picture to be coded and supplying motion vectors, a motion compensation predictor receiving the motion vectors and a reference picture and supplying an estimated picture, a reference picture memory storing at least two reference pictures and supplying one of said reference pictures to said predictor, and a block effect filter for filtering block effects from the reference pictures before the reference pictures are stored in the reference picture memory.

The invention further proposes a block decoding method with motion prediction, including reconstituting a transmitted picture from a reference picture selected from a plurality of received reference pictures that have undergone block effect filtering.

One embodiment of the method applies block effect filtering to the reconstituted pictures.

The invention further proposes a block decoding method with motion prediction, including a decoder supplying motion vectors and a difference between the picture to be reconstituted and an estimator picture, a motion compensation predictor receiving the motion vectors and a reference picture and supplying an estimated picture, a reference picture memory storing at least two reference pictures and supplying one of said reference pictures to said predictor, and a block effect filter filtering block effects in the reference pictures before the reference pictures are stored in the reference picture memory.

One embodiment of the system includes an adder receiving said difference and said estimated picture and supplying a reconstituted picture to said block effect filter.

The invention further proposes a block coding transmission method with motion prediction, comprising:

on coding, using a plurality of reference pictures that have undergone block effect filtering and selecting a reference picture from said reference pictures on coding a picture to be transmitted, and

on decoding, reconstituting the transmitted picture from a reference picture selected from a plurality of received reference pictures that have undergone block effect filtering.

In one embodiment transmission is at a low bit rate with a high error rate.

Another embodiment of the method applies block effect filtering to the reconstituted pictures.

The invention finally proposes a block coding transmission system with motion prediction including a coding system of the above kind and a decoding system of the above kind.

### BRIEF DESCRIPTION OF THE DRAWINGS

Other features and advantages of the invention will become apparent on reading the following description of embodiments of the invention, which is given by way of example and with reference to the accompanying drawings, in which:

FIG. 1 is a diagram showing a predictive coding system in accordance with the invention, and

FIG. 2 is a diagram showing a decoding system in accordance with the invention.

### MORE DETAILED DESCRIPTION

The invention proposes to use block edge filtering and a plurality of memory frames in a predictive block coding system of the kind proposed in the H.263+ standard. Solutions of the kind proposed in appendices J and N of the H.263+ standard are therefore combined in a system of the kind set out in the obligatory part of the standard. The invention is particularly advantageous in that block effects are filtered before the reconstituted pictures are stored in the picture memory. Block effects induced by coding are therefore neutralized, and using a plurality of memory pictures limits propagation time errors.

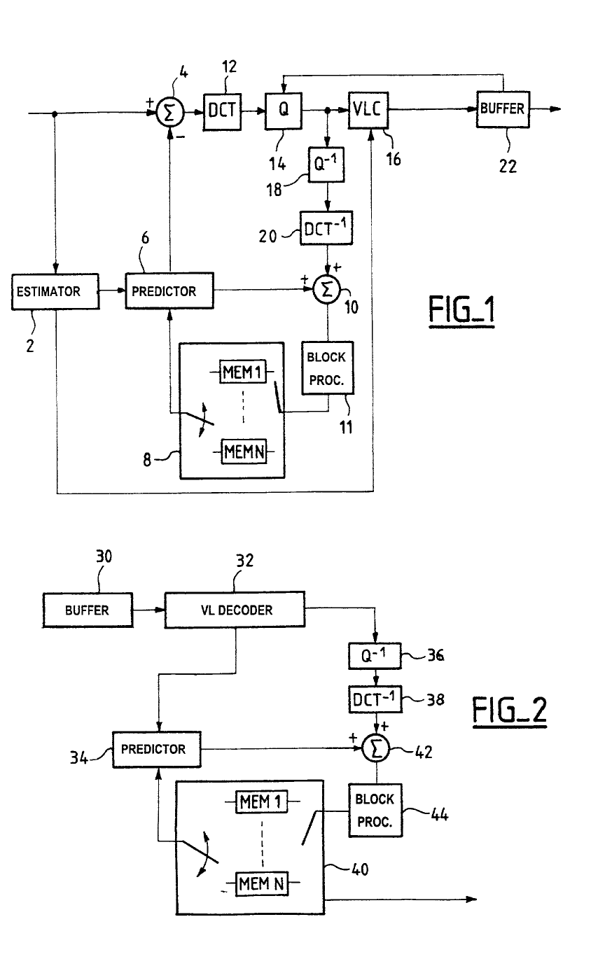

FIG. 1 is a diagram showing a predictive coding system according to the invention which uses a plurality of reference memory pictures. The video pictures at the input of the coding system are applied to a motion estimator 2 and to an input of a subtractor 4. The motion estimator supplies an estimate of the motion of blocks or macroblocks of the picture relative to the preceding picture; blocks of 8×8 pixels and macroblocks comprising six blocks of which four are luminance blocks and two are chrominance blocks can be used, as proposed in the standard. The motion vectors of the blocks are transmitted to a motion compensation predictor 6. For the purposes of estimation, the predictor also receives at its input a base picture from a reference picture memory 8. As proposed in appendix N of the standard, the reference picture memory contains a plurality of reference pictures and motion compensation is predicted relative to one of the reference pictures. To be more specific, the reference picture memory contains a plurality of stored pictures and a switch for supplying one of the pictures to the dispersion compensation predictor. The switch can be controlled as a function of various criteria, such as the quality of the reconstituted picture or the quantity of information to be transmitted, the principle of making the choice being known in the art. Similarly, and also in a manner that is known in the art, the picture used is transmitted from the coding system to the decoding system. The reference pictures are also updated in the decoding system at the command of the coding system.

In accordance with the invention, the reference pictures stored in the reference picture memory are processed to eliminate block effects before they are stored, as shown at 11 in FIG. 1 and explained in more detail below.

The motion compensation predictor supplies an estimated picture based on the reference picture and motion vectors and which is applied to a subtract input of the subtractor 4 and to an input of an adder 10.

The subtractor 4 therefore receives the input video picture and an estimated picture based on a reference picture contained in the basic picture memory. The estimated picture is subtracted from the video picture fed to the input in a compression coder 12, typically a discrete cosine transform coder. Quantizing is then carried out in a quantizer 14, preferably with a variable quantizing step. The output of the quantizer 14 is applied to a variable length coder 16 and to a quantizing inverter 18, which carries out the converse operation. The converse of the transform applied by the decoder 12 is applied at the output 20 of the quantizing inverter 18. The difference between the input picture and the estimated picture, as reconstituted after reception in the decoding system shown in FIG. 2 and in the absence of transmission errors, is obtained at the output of the coding inverter 20. This difference is fed to input of the adder 10. The adder 10 therefore outputs to the reference picture memory a reference picture (a picture that could be obtained after reception in the decoding system), possibly affected by transmission errors.

The variable length coder receives the output of the coder 14 and the output of the motion estimator 2, in other words the difference between the input picture and the estimated picture and the motion vectors. The output of the VLC is fed to a video buffer 22 before transmission over the channel; of course, the video signal can be multiplexed with audio or other signals before transmission; this is known in the art and has no effect on the functioning of the invention. If the quantizing step is variable, the quantity of information in the buffer can be used to control the quantizing step, as shown in FIG. 1 by the arrow connecting the buffer 22 to the quantizer 14.

In the system in accordance with the invention shown in FIG. 1, processing is effected to limit edge effects to the reference pictures stored in the reference picture memory. In the embodiment shown in this figure, this processing is applied at the output 11 of the adder 10, immediately before the reference pictures are stored in the reference picture memory. The reference pictures for predictive coding therefore feature no (or fewer) errors caused by the use of blocks to estimate motion. In other words, the solution of appendix N of the standard (making a choice from several reference pictures) now has only to alleviate transmission channel errors, and not errors intrinsic to the coding process.

FIG. 2 is a diagram showing a decoding system according to the invention. The decoding system receives information transmitted over the channel at a low bit rate in an input buffer 30. The received information is passed to a variable length decoder 32 whose function is the converse of that of the variable length coder of the FIG. 1 system. The variable length decoder 32 supplies motion vectors, which are fed to a motion compensation predictor 34, and the difference between the input picture and the estimated picture, which is fed to a quantizing inverter 36, similar to the inverter 18 shown in FIG. 1, and to an inverter 38, similar to the inverter 20 shown in FIG. 1.

The motion predictor receives a reference picture from a reference picture memory 40. As in the FIG. 1 memory, the reference picture memory contains a plurality of reference pictures and a switch feeds one of the reference pictures to the motion compensation predictor 34. As indicated above, the switch (reference picture selector) can be controlled as a function of information received over the transmission channel from the FIG. 1 coding system. Other solutions are possible, for example solutions based on local application in the decoding system of selection rules similar to those applied in the coding system: for the picture transmitted to be reconstructed correctly, it is only important that the reference picture selection process in the decoding system is identical to the reference picture selection process in the coding system. The motion compensation predictor produces an estimated picture, which is fed to an adder 42, from the motion vectors and the reference picture.

The adder 42 receives an estimated picture supplied by the motion compensation predictor and the difference between the estimated picture and the reference picture supplied by the inverter 38. It produces a reconstructed picture at its output.

That picture can then be displayed. It can also be stored and used as a reference picture. In this case, it is passed to a block effect limitation processing device 44 similar to the device 11 shown in FIG. 1. The reference picture memory 40 therefore contains reference pictures which, ignoring transmission errors, are identical to those contained in the reference picture memory 8 of the FIG. 1 system.

In the FIG. 2 embodiment, the displayed pictures are obtained at the output of the reference picture memory. This ensures that the pictures displayed have undergone edge effect limitation processing 44. Note that it is not indispensable to the invention for the pictures displayed to undergo this processing, however, because the reference pictures undergo it. It is nevertheless advantageous for the displayed pictures also to undergo edge effect limitation processing: the necessary means are present in the FIG. 2 system, and applying this processing can only improve the quality of the pictures displayed.

The preceding description refers only in passing to how the reference pictures are selected in the coding system or in the decoding system. Solutions known in the art can be used for this purpose.

Similarly, the nature of the edge effect limiting processing has been mentioned only in passing. The processing can be of the kind proposed in appendix J of the H.263+ standard. More generally, it is possible to use other solutions, for example by varying the number of pixels to which the filtering is applied, applying only horizontal filtering, applying only vertical filtering, or using a filter function other than that proposed in appendix J. Generally speaking, and as indicated above, the results of filtering are assessed qualitatively, in terms of the degree to which block effects are imperceptible to a user.

The invention improves the quality of video coding and applies in particular to transmission at low bit rates with a high error rate; it does not entail any drastic modification of the structure of the coder: all that is required, relative to the coder proposed in the common part of the H.263+ standard, is to provide the capacity to store a plurality of reference pictures and computing means to perform the block effect limitation processing. Similar means are required in the decoder.

Of course, the present invention is not limited to the examples and embodiments described and shown, many variants of which will suggest themselves to the skilled person. Thus the coding, quantizing and channel coding processes 12, 14 and 16 in FIG. 1, or the converse processes 38, 36 and 32 in FIG. 2, can vary. It is also clear that the invention relates not only to the combination of the coding system and the decoding system respectively shown in FIGS. 1 and 2, but also to each of them considered independently of the other. Similarly, the invention does not relate only to a transmission process with coding and decoding, but also to a coding process and to a decoding process each considered independently of the other.

1. A picture block coding method with motion prediction, using a plurality of reference pictures which have undergone block effect filtering and selecting a reference picture from said reference pictures when coding a picture.

2. A picture block coding system with motion prediction, including a motion estimator receiving a picture to be coded and supplying motion vectors, a motion compensation predictor receiving the motion vectors and a reference picture and supplying an estimated picture, a reference picture memory storing at least two reference pictures and supplying one of said reference pictures to said predictor, and a block effect filter for filtering block effects from the reference pictures before the reference pictures are stored in the reference picture memory.

3. A picture block decoding method with motion prediction, including reconstituting a transmitted picture from a reference picture selected from a plurality of received reference pictures that have undergone block effect filtering.

4. The method of claim 3, in which block effect filtering is applied to the reconstituted pictures.

5. A picture block decoding method with motion prediction, including a decoder supplying motion vectors and a difference between the picture to be reconstituted and an estimator picture, a motion compensation predictor receiving the motion vectors and a reference picture and supplying an estimated picture, a reference picture memory storing at least two reference pictures and supplying one of said reference pictures to said predictor, and a block effect filter filtering block effects in the reference pictures before the reference pictures are stored in the reference picture memory.

6. The system of claim 5, including an adder receiving said difference and said estimated picture and supplying a reconstituted picture to said block effect filter.

7. A block coding transmission method with motion prediction, comprising:
on coding, using a plurality of reference pictures that have undergone block effect filtering and selecting a reference picture from said reference pictures on coding a picture to be transmitted, and
on decoding, reconstituting the transmitted picture from a reference picture selected from a plurality of received reference pictures that have undergone block effect filtering.

8. The method of claim 7, wherein transmission is at a low bit rate with a high error rate.

9. The method of claim 7, including applying block effect filtering to the reconstituted pictures.

10. A block coding transmission system with motion prediction including a coding system according to claim 2 and a decoding system according to claim 5.

11. A block coding transmission system with motion prediction including a coding system according to claim 2 and a decoding system according to claim 6.
